(19) United States
(12) Patent Application Publication
(10) Pub. No.: US 2026/0030564 A1
(43) Pub. Date: Jan. 29, 2026

(54) A METHOD AND SYSTEM FOR TRACKING PROGRESS OF A CONSTRUCTION PROJECT

(71) Applicant: DIGITALBUILD PTE. LTD., Singapore (SG)

(72) Inventors: Ramamoorthy Rajendran, Singapore (SG); Baskar Kannan, Singapore (SG); Aswin Haran Hariharan, Singapore (SG)

(73) Assignee: DIGITALBUILD PTE. LTD., Singapore (SG)

(21) Appl. No.: 18/637,509

(22) Filed: Apr. 17, 2024

(30) Foreign Application Priority Data
Apr. 24, 2023 (SG) 10202301136Q

(51) Int. Cl. G06Q 10/0631

(52) U.S. Cl. CPC G06Q 10/0631

(57) ABSTRACT

The present invention discloses a server for tracking progress of a construction project, the server comprising a memory for storing instructions, a communication interface configured to receive input from a first client device and a second client device connected to the server, and a processor for executing the stored instructions and configured to receive, from a first client device connected to the server, a first input associated with one of the following: a project, a block, a floor or a unit, generate, by the server, a location matrix corresponding to the first input, wherein the location matrix includes one of the following: a project matrix, a block matrix, a floor matrix or a unit matrix.

### TECHNICAL FIELD

The present disclosure generally relates to a worksite management system. More particularly, it relates to a worksite management system and a method for tracking progress of a construction project.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

In the construction industry, tracking project progress and inspections is a complex process that involves multiple trades and a significant amount of manpower. Traditionally, construction progress has been monitored using manually filled-in charts, which are time-consuming and do not provide full visibility of the progress. Furthermore, paperwork and manual project tracking are known to cause copious amounts of pain and inconvenience to the project team.

Therefore, the present invention attempts to overcome at least in part some of the aforementioned disadvantages and to provide for an improved approach for addressing the foregoing challenge.

### SUMMARY OF THE INVENTION

According to various embodiments, there is provided a server for tracking progress of a construction project, the server comprising a memory for storing instructions, a communication interface configured to receive input from a first client device and a second client device connected to the server; and a processor for executing the stored instructions. The process is further configured to: receive, from a first client device connected to the server, a first input associated with one of the following: a project, a block, a floor or a unit, generate, by the server, a location matrix corresponding to the first input, wherein the location matrix includes one of the following: a project matrix, a block matrix, a floor matrix or a unit matrix, and receive, from the first client device, a second input associated with configuring a task checker, wherein the second input includes a plurality of tasks corresponding to the generated location matrix, a planned start date and a planned completion date. The processor is further configured to generate the task checker configured for a user to complete the plurality of tasks by the planned start date and the planned completion date and send, by the server, the task checker via a notification to a second client device.

In some embodiments, the processor is further configured to receive, from the second client device, a third input including a status of the plurality of tasks and an actual start date and an actual end date, and determine, by a matrix algorithm on the server, a current status indicator indicative of a current progress of the location matrix based on the third input and a weightage assigned to each of the plurality of tasks.

In some embodiments, the matrix algorithm is calculated as a percentage of the planned progress of the location matrix.

In some embodiments, the current status indicator provides an indication of the actual progress of the location matrix versus a planned progress of the location matrix.

In some embodiments, the processor is further configured to transmit a notification to the first client device based on the third input received by the second client device, wherein the notification includes the current status indicator.

In some embodiments, the current status indicator is an indication of the current status of the location matrix versus a planned status of the location matrix.

In some embodiments, the planned status of the location matrix is based on the planned start date and the planned end date of the location matrix.

In some embodiments, the first input further includes a request to create, view or manage a task.

In some embodiments, the location matrix comprises a location matrix hierarchy associated with one or more components of a building specification, wherein the location matrix hierarchy includes at least one of the following: a construction type, a block type, a floor type, a unit type, and a subunit type.

In some embodiments, the floor matrix includes an aggregate number of floors within the building.

According to various embodiments, there is provided a method for tracking progress of a construction project, the method comprising receiving, from a first client device connected to the server, a first input associated with one of the following: a project, a block, a floor or a unit, generating, by the server, a location matrix corresponding to the first input, wherein the location matrix includes one of the following: a project matrix, a block matrix, a floor matrix or a unit matrix, receiving, from the first client device, a second input associated with configuring a task checker, wherein the second input includes a plurality of tasks corresponding to the generated location matrix, a planned start date and a planned completion date. The method further comprises generating, by the server, the task checker configured for a second user to complete the plurality of tasks by the planned start date and the planned completion date, sending, by the server, the check list via a notification to a second client device.

In some embodiments, the method further comprises receiving, from the second client device, a third input including a status of the plurality of tasks and an actual start date and an actual end date, determining, by a matrix algorithm on the server, a current status indicator indicative of a current progress of the location matrix based on the third input and a weightage assigned to each of the plurality of tasks.

In some embodiments, the matrix algorithm is calculated as a percentage of the planned progress of the location matrix.

In some embodiments, the current status indicator provides an indication of the actual progress of the location matrix versus a planned progress of the location matrix.

In some embodiments, the processor is further configured to transmit, by the server, a notification to the first client device based on the third input received by the second client device, wherein the notification includes the current status indicator.

In some embodiments, the current status indicator is an indication of the current status of the location matrix versus a planned status of the location matrix.

In some embodiments, the planned status of the location matrix is based on the planned start date and the planned end date of the location matrix.

In some embodiments, the first input further includes a request to create, view or manage a task.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention will be better understood with reference to the detailed description when considered in conjunction with the non-limiting examples and the accompany drawings, in which:

FIG. 1 illustrates an infrastructure of a system including a system for managing progress of a construction project according to various embodiments;

FIG. 2 illustrates a block diagram of a worksite management system 100 for tracking progress of a project according to various embodiments;

FIG. 3 is block diagram of a location matrix hierarchy in accordance with embodiments of the present invention;

FIG. 4 is block diagram of a location matrix and its components in accordance with embodiments of the present invention;

FIG. 5 is a block diagram of client device in accordance with embodiments of the present invention;

FIG. 6 is a block diagram of a dashboard interface in accordance with embodiments of the present invention;

FIG. 7 is a flow chart of a method for tracking progress of a construction project in accordance with embodiments of the present invention.

### DETAILED DESCRIPTION

Reference will now be made in detail to an exemplary embodiment of the present invention, examples of which are illustrated in the accompanying drawings. While the invention will be described in conjunction with the embodiment, it will be understood that they are not intended to limit the invention to these embodiments. On the contrary, the invention is intended to cover alternatives, modifications, and equivalents, which may be included within the spirit and scope of the invention as defined by the appended description. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described. One skilled in the art will appreciate further features and advantages of the invention based on the above-described embodiments.

Embodiments described in the context of one of a server and a method are analogously valid for the other server and method. Similarly, embodiments described in the context of a server are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

Throughout the description, the term “module” may be understood as an application specific integrated circuit (ASIC), an electronic circuit, a combinational logic circuit, a field programmable gate array (FPGA), a processor which executes code, other suitable hardware components which provide the described functionality, or any combination thereof. The term of “module” may include a memory which stores code executed by the processor.

To achieve the stated features, advantages and objects, the present invention is directed to a worksite management system that handles the entire project management process in the construction domain. The worksite management system includes an application that generates a location matrix that enables real-time tracking and reporting of actual project progress against planned progress. The percentage of completion is automatically calculated using the location matrix algorithm, providing an accurate representation of project progress.

In general, embodiments of the present disclosure generate work tasks for remote and real-time tracking, checking, and inspections using a worksite management system. It also provides user interfaces for respective entities and stakeholders involved in the industry to update inputs on work tasks for real-time tracking of project progress. The worksite management system provides applications that integrate multiple entities and stakeholders of an industry providing real-time visibility, accountability and quality control. These applications are available to each of the stakeholders and entities using the worksite management system giving the entities and stakeholders flexibility to work in the field or virtually without the need for physical interaction. The worksite management system performs real-time reporting of industry specific metrics for each of the entities with the ability to see daily schedule variances of planned versus actual. Integrated alerts and messaging allow seamless connectivity to all entities for the users of the system. This results in the increased ability to manage scheduling and execution of jobs, reviews, and inspections at a worksite. The percentage of completion is automatically calculated providing an accurate representation of project progress.

The worksite management application is designed to be user-friendly and simple to use, with inputs keyed in via a mobile or web application using pre-arranged trade-wise checklists. This approach eliminates the need for complicated paperwork and manual tracking, making project management more efficient and streamlined. The software's simplicity and ease of use allow project teams to enter information quickly and without any complicated effort. Overall, the worksite management application offers a significant improvement over traditional manual project tracking and paperwork processes in the construction industry. This addresses some of the problems inherent in existing project or construction management applications.

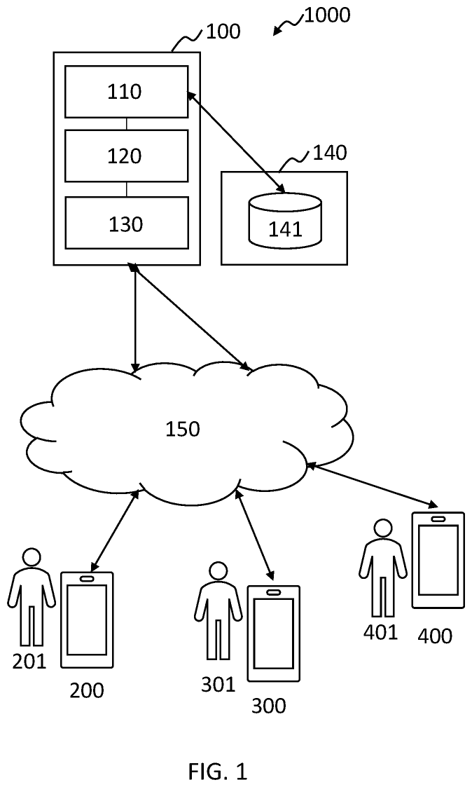

FIG. 1 illustrates an infrastructure of a system 200 including a server 100 for tracking progress of a project according to various embodiments. As shown in FIG. 1, the worksite management system 200 may include, but is not limited to, the server 100, a database system 140, a network 150, a computing device 160, and one or more other computing devices 170, 180.

In some embodiments, the network 150 may include, but is not limited to, a Local Area Network (LAN), a Wide Area Network (WAN), a Global Area Network (GAN), or any combination thereof. The network 150 may provide a wired communication, a wireless communication, or a combination of the wired and wireless communication between the server 100 and one or more client devices 200, 300, 400.

In some embodiments, the client device 200 may be connectable to the server 100 via the network 150 or through cloud technology. In some embodiments, the client device 200 may be arranged in data or signal communication with the server 100 via the network 150. In some embodiments, the client device 200 may include, but is not limited to, at least one of the following: a mobile phone, a tablet computer, a laptop computer, a desktop computer, a head-mounted display and a smart watch. In some embodiments, the client device 200 may be associated with the user 201. For example, the client device 200 may belong to the user 201, for instance, a worker, a supervisor, a manager, a builder or an inspector. It may be appreciated that the system 1000 may further include a plurality of client devices 300, 400 each associated with, for example, belonging to, a plurality of different users 301, 401 respectively.

In some embodiments, the client devices 200, 300, 400 may include a location sensor. In some embodiments, the location sensor may communicate with at least one of a global positioning satellite (GPS) server, a network server, and a Wi-Fi server, to detect a location of the client devices 200,300,400. In some embodiments, the client device 200, 300, 400 may generate information about the location of the computing device 200, 300, 400.

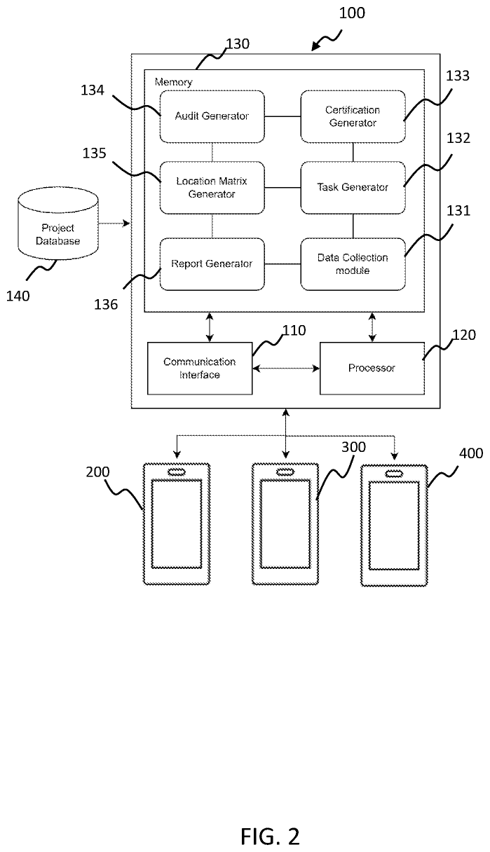

In some embodiments, the server 100, for example, implemented by a server computer, may include a communication interface 110, a processor 120, and a memory 130 (as will be described with reference to FIG. 2).

In some embodiments, the server 100 may communicate with the client device 200 via the network 150. In some embodiments, the client device 200 may receive an input (for example, a completion of a task) from the user 201 on the worksite management application. The client device 200 may send the input to the server 100 via the network 150. In some embodiments, the client device 200 may send a job completion together with a timestamp on the completion of a task from the client device 200 to the server 100 via the network 150.

In some embodiments, the system 200 may further include a database 141. In some embodiments, the database 141 may be a part of the database system 140 which may be external to the server 100. The server 100 may communicate with the database 141. In some other embodiments, although not shown, the database 141 may be implemented locally in the memory 130 of the server 100.

In some embodiments, the server 100 may communicate with the one or more client devices 200, 300, 400 for example, by a worker, a manager, a supervisor or an inspector, via the network 150. The one or more client devices 200 may be associated with one or more workers 201 respectively. For example, the one or more client devices 200, 300, 400 may belong to the one or more workers 201, one or more managers 301, one or more supervisors 401, respectively.

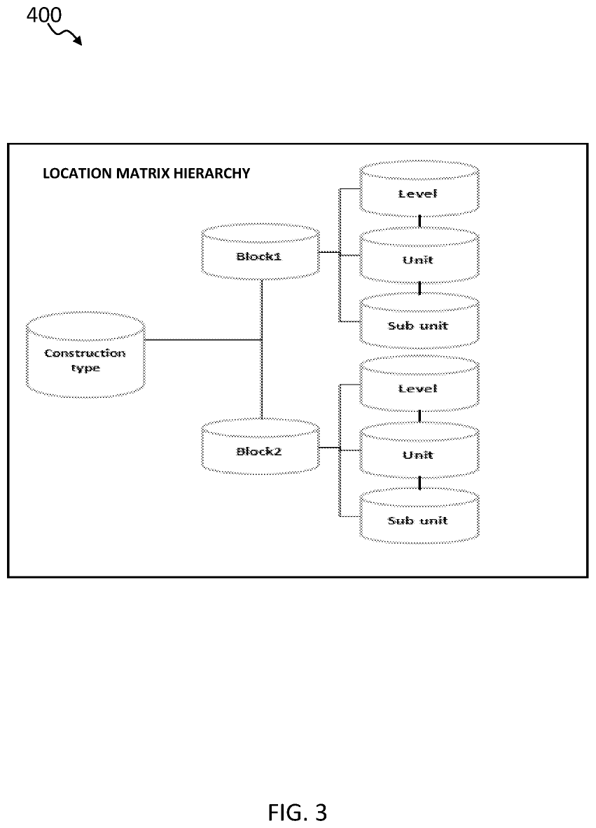

FIG. 2 illustrates a block diagram of a worksite management system 100 for tracking progress of a project according to various embodiments. As shown in FIG. 2, the worksite management application 100 implemented by a server, may include a communication interface 110, a processor 120, and a memory 130. In some embodiments, the memory 130 (also referred to as a “database”) may store input data and/or output data temporarily or permanently. In some embodiments, the memory 130 may store program code which allows the worksite management application 100 to perform a method 300 (as will be described with reference to FIG. 3). The memory also includes various modules and applications for performing certain tasks, details of which will be explained later. In some embodiments, the program code may be embedded in a Software Development Kit (SDK). The memory 130 may include an internal memory of the server 100 and/or an external memory. The external memory may include, but is not limited to, an external storage medium, for example, a memory card, a flash drive, and a web storage.

In some embodiments, the communication interface 110 may allow one or more computing devices, including a client device 160, to communicate with the processor 120 of the worksite management application via a network 150, as shown in FIG. 1. In some embodiments, as shown in FIG. 1, the client device 160 may belong to a user 161 who has to perform tasks and input updates into the client device. In some embodiments, the communication interface 110 may transmit signals to the client device 160, and/or receive signals from the client device 160 via the network 150.

In some embodiments, the communication interface 110 may allow one or more client devices 170, 180, for example, other entities and stakeholders involved in the project such as builders, managers, supervisors and inspectors, to communicate with the processor 120 of the server 100 via the network 150, as shown in FIG. 1. In some embodiments, the communication interface 110 may transmit signals to the one or more client devices 170, 180, and/or receive signals from the one or more client devices 170, 180, via the network 150.

In some embodiments, the communication interface 110 may further receive information about a location of the computing device 160 from the computing device 160 via the network 150. The communication interface 110 may then send the information about the location of the computing device 160 to the processor 120.

The processor 120 may include, but is not limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 120.

In some embodiments, the processor 120 may be connectable to the communication interface 110. In some embodiments, the processor 120 may be arranged in data or signal communication with the communication interface 110 to receive data and updates on work tasks from the client device 200 or information about the location of the client device 200.

The worksite management system 100 includes a memory 130 that includes various applications including a location matrix generator 135, an audit generator 134, a task generator 132, a report generator 136, a certification generator 133 and a data collection module 131. In some embodiments, a worksite is a location where jobs are performed by various entities and stakeholders invested in the worksite. For example, a worksite is a location of a property development for a residential, commercial or office building.

The worksite management system 100 is in communication with a project database 140. The project database 140 stores information such as building specifications of one or more property developments. A building specification is a document that outlines the requirements for a construction project. It includes detailed information about the characteristics of a building such as floors, units and subunits and dimensions thereof. It also includes information about materials, finishes, and fixtures that will be used in the project, as well as any special requirements or considerations that need to be taken into account. The specification may also include information about the construction process itself, such as how the work will be carried out and what safety measures will be put in place. The project database 140 may be stored on server that is hosted or provided by a cloud services provider. The cloud services provider provides hosting, virtualization, and data storage services to operate and control the data, programs and applications that store and retrieve data from the project database 140.

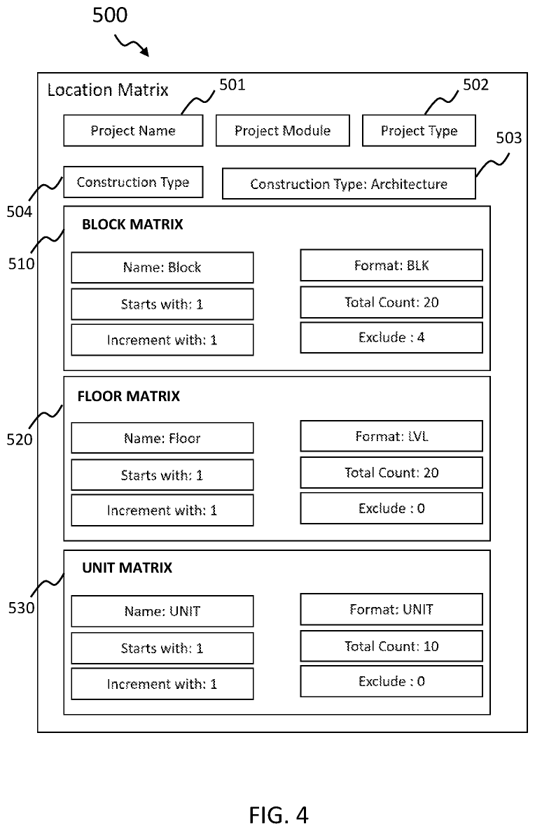

FIG. 3 is block diagram of a location matrix hierarchy and FIG. 4 is block diagram of a location matrix and its components in accordance with embodiments of the present invention. The location matrix generator 135 converts the building specification from the project database 140 into a location matrix. The location matrix hierarchy is a hierarchy of a building specification that is broken down into its individual components from a high level component to a low level component. For example, in some embodiments, and with reference to FIG. 3, the location matrix generator generates a location matrix hierarchy comprising components of a building specification into its construction type, block type, level type, unit type and subunit type corresponding to each construction type. In some embodiments, and with reference to FIG. 4, the location matrix generator 135 generates a location matrix comprising components of a building specification such as the project name, project type, construction type, a block matrix, a floor matrix, and a unit matrix. In some embodiments, the location matrix generator generates a block matrix comprising the total number of floors, units and subunits within a block, when there are more than one block within a development. In some embodiments, the location matrix generator generates a floor matrix comprising the total number of floors within the development, including when there are more than one block within the development. In some embodiments, the location matrix generator generates a unit matrix comprising the total number of units, unit type and unit layout. In some embodiments, the location matrix generator generates a subunit matrix comprising the total number of subunits, subunit type, and subunit layout.

In general, a building specification provides detailed information on materials, dimensions and other characteristics of a building to ensure the building is constructed according to the design and for meeting the relevant codes and standards. In some embodiments, a floor specification is provided that includes the number of floors, height of each floor, materials used for flooring, and any special features such as balconies. In some embodiments, a unit specification is provided that includes the number of units, the size and layout of each unit, and any special features such as balconies or planters. In some embodiments, a unit is subdivided into subunits such as bedrooms, kitchen and bathrooms. A subunit specification is provided that includes subunit type, number of subunits, size and layout of each subunit, and any other special features such as built in cabinets.

The task generator 132 is generated from the location matrix generated by the location matrix generator 135. The task generator 132 generates a schedule, a task checker or a check list that is configured by a maker for a checker to perform and update tasks on the schedule or check list. The task checker or check list includes a schedule of tasks performed daily or weekly or within a predetermined time period. The task checker or check list provides an overview of the work to be carried out for a block, a floor, a unit or a subunit, or a unit type or a subunit type.

The report generator 136 generates a report that can be generated when desired by a specific stakeholder who has access to the report generator. The report includes information generated on completed or uncompleted schedules, and can include information from the audit generator, task generator location matrix generator or the data collection module. The report also provides real-time information on daily schedule variances of planned versus actual. The report may also be generated automatically as a form of alert or messaging as configured by users of the worksite management system to various stakeholders. This provides seamless connectivity to all stakeholders of the project. This results in the increased ability to manage scheduling and execution of jobs, reviews, and inspections at a worksite. The percentage of completion is automatically calculated providing an accurate representation of project progress.

The audit generator 134 generates an audit report. The audit report can be generated once an inspector or a manager or an auditor has confirmed that quality control standards have been satisfied according to specific audit schedules generated by the task generator 132. In some embodiments, audit schedules and audit checklists are generated for predetermined stages of completion of the development to ensure that standards are met. The standards may include but are not limited to quality control, building, material, or engineering standards. Once the inspector or manager or engineer has performed and updated the tasks on the audit schedule, the audit report can be generated and sent to the respective stakeholders in the form of a report as and when desired. The audit report can include audit information on processes, activities and the results of activities carried out during a stage. For example, a foundation stage audit repot can comprise a test result for the parts of the foundation, a video of a part of the foundation, a photograph of a part of the foundation, a result of a visual inspection, a time overrun, a cost overrun, an item cost, a cost of personnel, a total cost, a reason for a delay, a note, a number of personnel, a cost underrun, a substitution, a reason for a substitution, and any combination thereof. In some embodiments, the audit report may include building code violations that need to be remediated before construction can continue.

The certification generator 133 generates a certification or a permit for tasks completed on a worksite. For example, a builder may request for a permit from an inspector from a governing authority to ensure that building codes have been met. A certification check list can be generated by the worksite management system 100 for an inspector to access the certification check list and to conduct the inspection based on the items in the certification check list. Once the inspector has verified and performed the check list, a report is generated by the certification generator 133 and sent to stakeholders of the project. If the report indicates that the building codes and safety standards have been met, a certificate or a permit will be issued to allow construction to continue. If not, the report will indicate the remedies to be made to satisfy building codes and/or safety standards so that construction can continue.

The data collection module 131 is a data repository comprising the collection of data of all the various modules and applications in the worksite management system 100. The data is configured for ease of data retrieval, modification, re-organization and deletion.

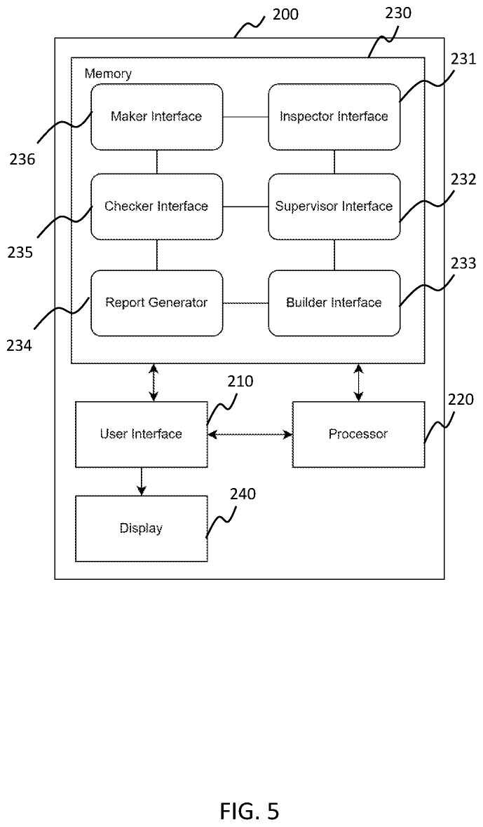

FIG. 5 illustrates a client device according to various embodiments. The client device 200 includes a user interface 210, a processor 220, a display and a memory 230. The client device is a computing system and includes but not limited to at least one of the following: a mobile phone, a tablet computer, a laptop computer, a desktop computer, a head-mounted display and a smart watch. In some embodiments, the users of the client device 200 includes but is not limited to a worker, a supervisor, a manager, a builder or an inspector.

As shown in FIG. 5, the worksite management application includes a user interface 210, a processor 220, and a memory 230. In some embodiments, the memory 130 (also referred to as a “database”) may store input data and/or output data temporarily or permanently. In some embodiments, the memory 130 may store program code which allows the worksite management application to perform a method (as will be described with reference to FIG. X). The memory also includes various modules and applications for performing certain tasks, details of which will be explained later. In some embodiments, the program code may be embedded in a Software Development Kit (SDK). The memory 230 may include an internal memory and/or an external memory. The external memory may include, but is not limited to, an external storage medium, for example, a memory card, a flash drive, and a web storage.

In some embodiments, the user interface 210 allow users to communicate with the worksite management application via a network 150, as shown in FIG. 1. In some embodiments, a user performs tasks and input updates into the client device via the user interface. In some embodiments, the user interface 210 transmit signals to the worksite management system 100, and/or receive signals from the worksite management system 100 via the network 150.

The worksite management application on the client device 200 includes several interfaces which are interfaces to the applications running on the worksite management application on the client device 200. The interfaces may be part of a native application or may be a browser application that sends and receives data to and from the worksite management application. The interfaces are presented to a specific user depending on the access level accorded to the user. For example, a maker interface 236 is only accessible by a creator of a schedule or check list. The creator may include but is not limited to an engineer, a builder, a contractor or a supervisor.

The builder interface 233 executes on the client device 200 and is used by a builder to access the worksite management application to view or create schedules, notifications, or receive messages. For example, a builder may use the builder interface 233 to plan project timeline schedules for the building development. The project timeline schedules include planned start dates and planned completion dates of the construction of the building including each block, floor, units and subunits.

The supervisor interface 232 executes on the client device 200 and is used by a supervisor to access the worksite management application to view or manipulate schedules, send and receive notifications and messages, etc. For example, a supervisor of a contractor may use the supervisor interface 232 to generate reports from the application for the purposes of tracking the status update of the project timeline schedules. The supervisor interface 232 also allows the supervisor to schedule specific workers for a project. In some embodiments, the supervisor access the supervisor interface 232 to review completed check lists and evidence of the work performed at a worksite.

The checker interface 235 executes on the client device and is used by a worker to access the system to view and manipulate schedules, notifications, messages, etc. For example, a worker may be at a worksite and use the checker interface to update that one or more tasks associated with the check list are complete. In some embodiments, the worker may also update with comments or upload an image with evidence of completion of a certain task on the check list.

The inspector interface 231 executes on the client device and is used by an inspector to access the system to view and manipulate schedules, notifications, messages, etc. In some embodiments, an inspector interface 231 is only accessible by a supervisor, an inspector, an official from a governing authority, or someone in the capacity of ensuring that the project meets building codes or safety standards. For example, an inspector may use the inspector interface 231 to review the evidence of the work performed at a worksite.

The interfaces 231, 232, 233, 235, 236 interactively display information from multiple applications running on the client device and the server. The applications running on the client device communicate with the worksite management system through the worksite management application programming interface.

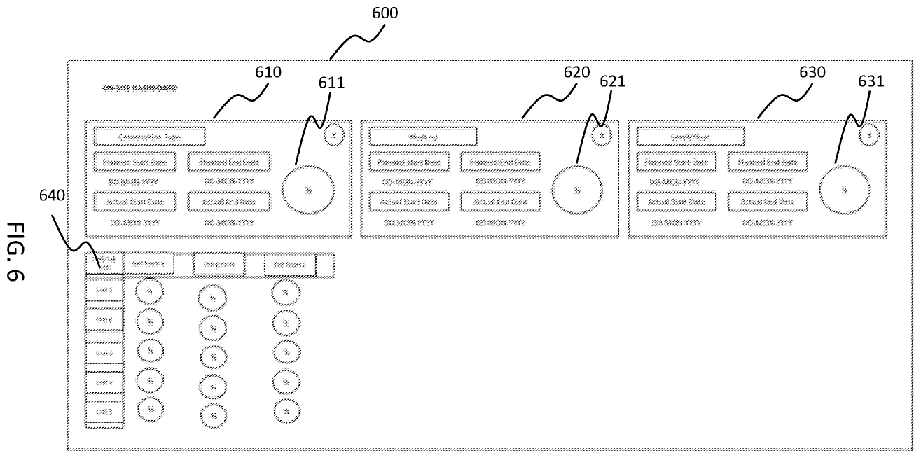

FIG. 6 illustrates a dashboard interface on the client device 200 according to various embodiments. The dashboard interface includes components of the location matrix and a status indicator associated with each component of the location matrix. For example, the dashboard interface includes a construction matrix, a block matrix, a floor matrix and a unit matrix. For example, the construction matrix includes a construction type, a planned start date, a planned completion date, an actual start date and an actual completion date, and a construction status indicator. The construction status indicator provides the current state of completion of the overall project construction in percentage terms. In some embodiments, the block matrix includes a block type, a planned start date, a planned completion date, an actual start date and an actual completion date, and a block status indicator. The block status indicator provides the current state of completion of the specific block in percentage terms. In some embodiments, the unit matrix includes a unit type, a planned start date, a planned completion date, an actual start date and an actual completion date, and a unit status indicator. The unit status indicator provides the current state of completion of the specific unit type in percentage terms. In some embodiments, the unit matrix provides a breakdown of each unit into its subunit types and subunit type status indicator. For instance, a unit type may include a bedroom 1, a bedroom 2, a living room, a kitchen, etc. The unit matrix includes a subunit status indicator that provides a current state of completion of each subunit of the unit in percentage terms.

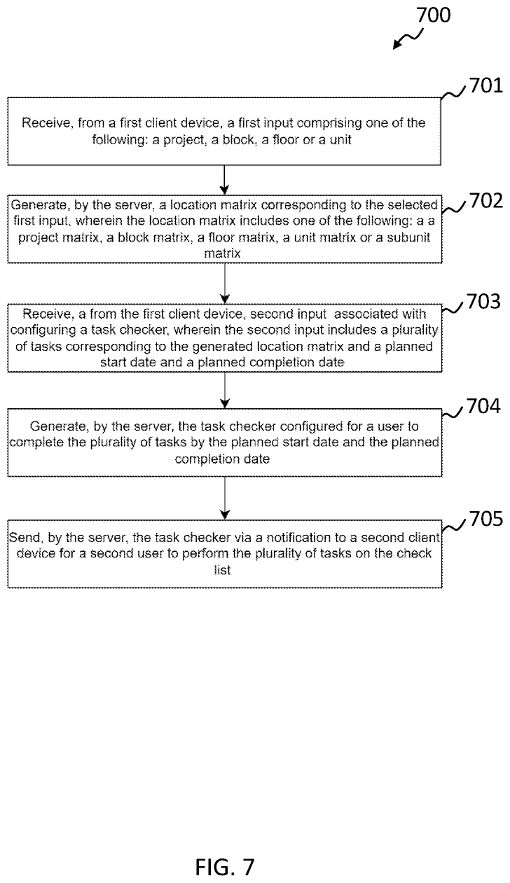

FIG. 7 illustrates a flowchart of a method for tracking the progress of a construction project. At step 701, the worksite management system 100 receives a first input from a user interface on a first client device. The first input is received from a user associated with the user interface, In various embodiments, the user is a builder who inputs the first input on a builder interface. In other embodiments, the user is a maker, an engineer, a manager, a supervisor or an inspector. In some embodiments, step 701 may be performed when a user inputs the first input to request to create, view or manage a schedule or task that involves at least one of the following: a project, a block, a floor or a unit. In some embodiments, step 701 may be executed after a user provides a send instruction.

At step 702, the worksite management system generates a location matrix corresponding to the first input received by the client device. The location matrix generated includes one of the following: a project matrix, a block matrix, a floor matrix, a unit matrix or a subunit matrix. For example, if the first input received from the first client device was associated with a block, the location matrix will generate a block matrix, and if the first input was associated with a floor, the location matrix will generate a floor matrix. In various embodiments, the location matrix generator 135 generates a block matrix comprising the total number of floors, units and subunits within a block, when there are more than one block within a development. In some embodiments, the location matrix generator generates a floor matrix comprising the total number of floors within the development, including when there are more than one block within the development. In some embodiments, the location matrix generator generates a unit matrix comprising the total number of units, unit type and unit layout. In some embodiments, the location matrix generator generates a subunit matrix comprising the total number of subunits, subunit type, and subunit layout.

At step 703, the worksite management system receives a second input from the first client device. The second input selection is associated to one or more actions related to configuring a check list or a task checker for performance by a checker. The check list or task checker includes a plurality of tasks corresponding to the generated location matrix and a planned start date and a planned completion date for the generated location matrix. For example, if the generated location matrix relates to a unit matrix, the second input is associated with actions to configure the check list for a unit matrix, for example, the user may be prompted to input information such as “Paint walls”, “Plumbing”, “Install Windows”, etc.. In various embodiments, one or more predetermined templates are available for a user to select based on the unit type configuration, floor type, subunit type, or block type.

At step 704, the server generates the task checker or check list configured by the user of the first client device. The task checker or check list is designed for a second user to complete the plurality of tasks in the check list by the planned start date and the planned completion date.

At step 705, the server sends a notification to the second user of a second client device to inform the user of the check list or task checker assigned to the user. The second user is but not limited to a worker or an inspector in the capacity of ensuring that the construction is meeting building codes and standards.

In various embodiments, the worksite management system is further configured to receive a third input from the second client device. The third input includes a status of the plurality of tasks and an actual start date and an actual end date from the second client device.

In various embodiments, the server determines, based on the third input received from the second client device, a current status indicator associated with the progress for the location matrix.

In various embodiments, the server is further configured to transmit a notification to the first client device based on the third input received by the second client device, wherein the notification includes the current status indicator. The current status indicator is an indication of the current status of the location matrix versus a planned status of the location matrix.

In various embodiments, the worksite management system incorporates a unique workflow process for built projects based on the location matrix. The location matrix is generated by the location matrix generator and includes a matrix algorithm that captures the work progress based on the user input, and validates the completion based on predetermined template standards and documents. For example, a Quality Assurance document and Inspection Report can be generated by the location matrix generator assigned for the particular trade, floor, block, unit, and sub units of a block. This unique feature confirms the streamlined approach of the work progress with detailed information and statistics about the work progress from the macro to micro levels.

In various embodiments, after completion of the plurality of tasks associated with a quality assurance document or an inspection report, the matrix algorithm converts the Quality Assurance, Inspection and approval documents into electronic certificates for authenticity. It also confirms the non-violation of the processes for each task under each location matrix. Authenticated electronic certificates can also be used for audit purposes. The electronic certificate also enables the builder to pay the contractors/sub-contractors for each task after the work is complete.

In various embodiments, the matrix algorithm automatically calculates the percentage of work completion based on the generated location matrix. In order to calculate the current status indicator of each location matrix indicating the progress done for each location matrix, the matrix algorithm takes into account user input as well as the weightage assigned to each task. For example, if the task relates to installation of windows for a unit matrix (the unit matrix indicates a specific unit type within a block), if the assumption is made that installing the window is 20% of the total work done for the unit matrix, the matrix algorithm then applies a predetermined weightage to each level of the hierarchy. If the unit matrix indicates that there are 5 units associated to the unit matrix, each unit is weighted equally. The current status indicator will be recalculated such that each unit contributes 4% to the total. Then the current status indicator is determined by the workers assigned to each unit confirming if the task has been done. If only 3 of the 5 units are completed the tasks, then the current status indicator will be 3*4=12% complete, not 20% as claimed. It will only reach 20% when all 5 units have confirmed completion.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A server for tracking progress of a construction project, the server comprising: a memory for storing instructions;
a communication interface configured to receive input from a first client device and a second client device connected to the server; and
a processor for executing the stored instructions and configured to:
receive, from a first client device connected to the server, a first input associated with one of the following: a project, a block, a floor or a unit;
generate, by the server, a location matrix corresponding to the first input, wherein the location matrix includes one of the following: a project matrix, a block matrix, a floor matrix or a unit matrix;
receive, from the first client device, a second input associated with configuring a task checker, wherein the second input includes a plurality of tasks corresponding to the generated location matrix, a planned start date and a planned completion date;
generate, by the server, the task checker configured for a user to complete the plurality of tasks by the planned start date and the planned completion date;
send, by the server, the task checker via a notification to a second client device.

2. The server according to claim 1, wherein the processor is further configured to:
receive, from the second client device, a third input including a status of the plurality of tasks and an actual start date and an actual end date;
determine, by a matrix algorithm on the server, a current status indicator indicative of a current progress of the location matrix based on the third input and a weightage assigned to each of the plurality of tasks.

3. The server according to claim 2, wherein the matrix algorithm is calculated as a percentage of the planned progress of the location matrix.

4. The server according to claim 2, wherein the current status indicator provides an indication of the actual progress of the location matrix versus a planned progress of the location matrix.

5. The server according to claim 2, wherein the processor is further configured to:
transmit, by the server, a notification to the first client device based on the third input received by the second client device, wherein the notification includes the current status indicator.

6. The server according to claim 2, wherein the current status indicator is an indication of the current status of the location matrix versus a planned status of the location matrix.

7. The server according to claim 6, wherein the planned status of the location matrix is based on the planned start date and the planned end date of the location matrix.

8. The server according to claim 1, wherein the first input further includes a request to create, view or manage a task.

9. The server according to claim 1, wherein the location matrix comprises a location matrix hierarchy associated with one or more components of a building specification, wherein the location matrix hierarchy includes at least one of the following: a construction type, a block type, a floor type, a unit type, and a subunit type.

10. The server according to claim 1, wherein the floor matrix includes an aggregate number of floors within the building.

11. A method for tracking progress of a construction project, the method comprising:
receiving, from a first client device connected to the server, a first input associated with one of the following: a project, a block, a floor or a unit;
generating, by the server, a location matrix corresponding to the first input, wherein the location matrix includes one of the following: a project matrix, a block matrix, a floor matrix or a unit matrix;
receiving, from the first client device, a second input associated with configuring a task checker, wherein the second input includes a plurality of tasks corresponding to the generated location matrix, a planned start date and a planned completion date;
generating, by the server, the task checker configured for a second user to complete the plurality of tasks by the planned start date and the planned completion date;
sending, by the server, the check list via a notification to a second client device.

12. The method according to claim 11 further comprising:
receiving, from the second client device, a third input including a status of the plurality of tasks and an actual start date and an actual end date;
determining, by a matrix algorithm on the server, a current status indicator indicative of a current progress of the location matrix based on the third input and a weightage assigned to each of the plurality of tasks.

13. The method according to claim 12, wherein the matrix algorithm is calculated as a percentage of the planned progress of the location matrix.

14. The method according to claim 12, wherein the current status indicator provides an indication of the actual progress of the location matrix versus a planned progress of the location matrix.

15. The method according to claim 12, wherein the processor is further configured to:
transmit, by the server, a notification to the first client device based on the third input received by the second client device, wherein the notification includes the current status indicator.

16. The method according to claim 12, wherein the current status indicator is an indication of the current status of the location matrix versus a planned status of the location matrix.

17. The method according to claim 16, wherein the planned status of the location matrix is based on the planned start date and the planned end date of the location matrix.

18. The server according to claim 11, wherein the first input further includes a request to create, view or manage a task.
